(19) United States
(12) Patent Application Publication
(10) Pub. No.: US 2018/0197501 A1
(43) Pub. Date: Jul. 12, 2018

(54) DISPLAY CONNECTION SWITCHING

(71) Applicant: Intel Corporation, Santa Clara, CA (US)

(72) Inventors: Karthik Veeramani, Hillsboro, OR (US); Rajneesh Chowdhury, Portland, OR (US); Paul S. Diefenbaugh, Portland, OR (US)

(73) Assignee: Intel Corporation, Santa Clara, CA (US)

(21) Appl. No.: 15/400,852

(22) Filed: Jan. 6, 2017

(51) Int. Cl. G09G 5/00; G06F 3/14; H04N 21/4363; H04N 5/44; H04N 5/268; H04N 5/38; H04N 21/436; H04N 21/442

(52) U.S. Cl. CPC G09G 5/006; G06F 3/1423; H04N 21/43635; H04N 21/43637; H04N 5/44; G09G 2370/16; H04N 5/38; H04N 21/43615; H04N 21/44227; G09G 2370/12; H04N 5/268

(57) ABSTRACT

In one example, an apparatus includes storage to store instructions executable by at least one processor, and at least one processor to execute the instructions. When executed, the instructions cause at least one processor to determine a first connection made between a display content transmitting device and a display content receiving device. In response to the determined first connection, the instructions also cause the at least one processor to activate a second connection between the display content transmitting device and the display content receiving device, to pause the second connection, to determine a deactivation of the first connection, to un-pause the second connection in response to the deactivation of the first connection, and to stream display content from the transmitting device to the receiving device via the second connection.

### TECHNICAL FIELD

This disclosure relates generally to automatic switching from one display connection (or interconnect) to another display connection (or interconnect).

### BACKGROUND

A user may want to connect an electronic transmitting device to a receiving device in order to display content from the electronic device. These connections between a transmitting device and a receiving device can be wired or wireless in nature. Some devices can transmit one or more images to be displayed, and some devices can receive a transmission and then forward the transmission or display images in response to the transmission. Both transmitting and receiving devices can be enabled to connect using a variety of wired and wireless connection protocols.

### BRIEF DESCRIPTION OF THE DRAWINGS

The following detailed description may be better understood by referencing the accompanying drawings, which contain specific examples of numerous features of the disclosed subject matter.

FIG. 1 illustrates a display connection system;

FIG. 2 illustrates a display connection switching system;

FIG. 3 illustrates display connection switching;

FIG. 4 illustrates a computing device;

FIG. 5 illustrates a processor and one or more non-transitory computer readable media;

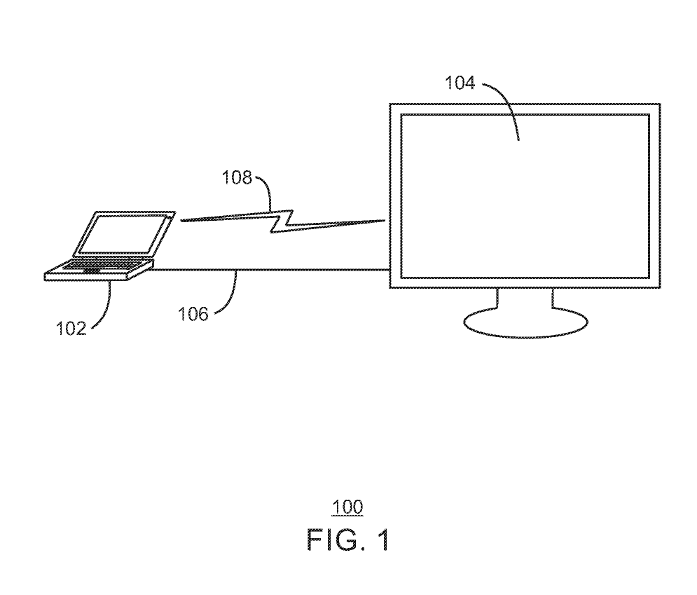

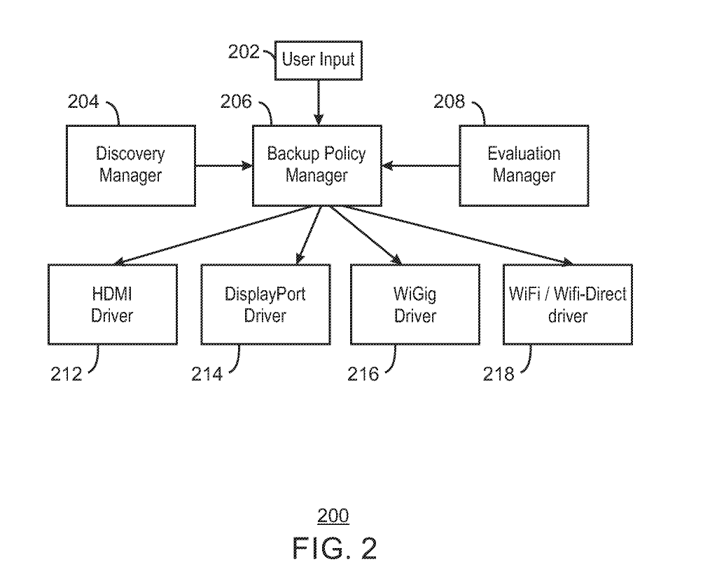

In some cases, the same numbers are used throughout the disclosure and the figures to reference like components and features. In some cases, numbers in the 100 series refer to features originally found in FIG. 1; numbers in the 200 series refer to features originally found in FIG. 2; and so on.

### DESCRIPTION OF SOME EMBODIMENTS

Extending or sharing a display of a device with another device via a wired and/or wireless communication interface can be a preferred usage model for a user. Transmitters and/or receivers of content can communicate via a wide range of wired and wireless communication protocols. When a device shares content using a wired interface, an interruption can occur of the transmission of the content between the transmitting device and the receiving device. This can cause an interruption in viewing of the receiving content on a display device. If the transmitting device and/or the receiving device need to unplug a wired connection, for example, delays in display of the content can be experienced. For example, this might occur if a receiving device includes a monitor with one display/charging port and the user wishes to charge another device in that port while still continuing to share content from an originally connected device.

In some embodiments, a display switching system can seamlessly switch from wired to wireless display. Users can continue viewing content on a display screen in an uninterrupted manner even if a primary transmitting device is disconnected from a wired interface for some reason. In some embodiments, policy management can choose a best available transport mechanism available for a backup connection in case a primary current connection link is interrupted, unplugged, etc.

In some embodiments, a display session can be instantaneously continued using a wireless connection when a wired connection link is disconnected (for example, unplugged). This can be implemented without any manual effort by a user. In some embodiments, a wireless connection can be set up in the background in a paused mode upon establishment of a wired connection. Content can be transmitted over the wired connection until it is disconnected for some reason. Upon disconnect of the wired connection, the wireless connection can be immediately un-paused without any setup time at that point involving, for example, negotiating a wireless connection, setting up a media pipeline, etc. before the wireless connection can begin showing content. According to some embodiments, the wireless connection is set up in advance so that those types of activities need not be done upon a sudden disconnect of the wired connection. For example, with a Miracast wireless connection, setting up the wireless connection at time of wired connection disconnect might take 7 to 10 seconds or so, resulting in content not being able to be displayed to a user during that time. However, in some embodiments, this 7 to 10 second delay need not occur since the wireless connection is set up around the time of initial wired connection and is waiting in a paused mode until occurrence of a disconnect of the wired connection. In some embodiments, an enhanced user experience can be provided since a backup connection (for example, a backup wireless connection) is implemented due to establishment of the backup connection upon a connection event of a link such as a wired link rather than being established upon a disconnection event of that link.

Some embodiments relate to automatic switching from one display connection (or interconnect) to another display connection (or interconnect). In some embodiments, upon disconnection of a wired display connection (or interconnect) between a transmitting device (for example, such as an electronic device and/or a computing device) and a receiving device (for example, such as a display device), a wireless connection (or interconnect) between the transmitting device and the receiving device that has been established in the background can be used to seamlessly connect the transmitting device and the receiving device in a manner that provides uninterrupted viewing of display content on the receiving device and/or on another device. This can be implemented without any interruption noticeable to one or more viewers of the content on a display device such as the receiving device and/or another device to which the receiving device transmits the content. In some embodiments, seamless switching from a first connection to a second connection can be implemented so that users can continue viewing content on a display screen when the first connection becomes disconnected. In some embodiments, seamless switching from a wired connection to a wireless connection can be implemented so that users can continue viewing content on a display screen when the wired connection becomes disconnected. In some embodiments, seamless switching from a wireless connection to a wired connection can be implemented so that users can continue viewing content on a display screen when the wireless connection becomes disconnected.

FIG. 1 illustrates a display connection system 100. Display connection system 100 includes a computing device 102 and a display device 104. The computing device 102 illustrated in FIG. 1 looks like it could be a laptop computing device. However, computing device 102 can be any computing device in some embodiments. In some embodiments, computing device 102 can be any computing device that can output data that could be displayed on a display device. In some embodiments, computing device 102 can be, for example, a mobile phone, smart phone, mobile device, handset, laptop computer, desktop computer, tablet computer, cable box, television (TV), high definition television (HDTV), satellite box, set top box, video and/or image streaming device, video and/or image transmitting device, Apple TV device, Chromecast device, and/or Roku device, among others. In some embodiments, computing device 102 can be a device with its own built in display. In some embodiments, computing device 102 can be a device that does not have its own built in display. In some embodiments, display device 104 can be a high definition (HD) display device, computer monitor, television (TV), high definition television (HDTV), a projector, a repeater, a re-transmitter, a streaming device, and/or a display hub, among others.

Computing device 102 and display device 104 can be coupled to each other via a wired interconnect 106 and/or via a wireless interconnect 108. In some embodiments, wired interconnect 106 can be, for example, a wired interconnect that can transmit data using a high-definition multimedia interface (HDMI) protocol, Thunderbolt protocol, DisplayPort protocol, Digital Visual Interface (DVI), Video Graphics Array (VGA), Display over USB (USB Display), and/or using some other wired protocol, communication link, and/or other wired communication methodology. In some embodiments, wireless interconnect 108 can be, for example, a wireless interconnect that can transmit data using Miracast, Wireless Gigabit Alliance (WiGig), Wireless Display (WiDi), WiFi, WiFi-Direct, Apple Airplay, Google Chromecast, and/or using some other wireless protocol, communication link, and/or other wireless communication methodology.

In some embodiments, computing device 102 can be referred to as a transmitter device (Tx), and display device 104 can be referred to as a receiver device (Rx). In some embodiments, computing device 102 and display device 104 can connect via wired interface 106 in order to share content (for example, in order for the computing device 102 to share content with the display device 104). Upon connection via the wired interface 106, the computing device 102 can also set up the wireless interface 108 with display device 104, with the wireless interface 108 running in the background. In this manner, computing device 102 can keep the wireless connection 108 as a backup so that a sharing session between the computing device 102 and the display device 104 that is occurring via wired connection 106 can continue in an uninterrupted fashion using the wireless connection 108 if the wired connection 106 is unplugged or disconnected for some reason. In some embodiments, this is implemented through a seamless switch from the wired connection 106 to the wireless connection 108 in order to continue the sharing session of the shared content between the computing device 102 and the display device 104.

In some embodiments, the backup connection on wireless interface 108 can be set up based on some cues. For example, in some embodiments, the backup connection via the wireless interface 108 can be set up in response to, for example, a hot plug event that is emitted when a connection is established between computing device 102 and display device 104 on wired connection 106. For example, when a transmitter such as computing device 102 connects to a receiver such as display device 104 via a wired connection 106 (for example, an HDMI connection), a wireless connection 108 (for example, a Miracast connection) can be automatically established between the transmitter computing device 102 and the receiver display device 104 in the background. The established wireless connection (Miracast connection) can be maintained in a paused state as long as the wired connection (HDIM connection) is alive. When the wired connection is ended due to an unplug of the wired connection 106, for example, the wireless connection is automatically un-paused (activated) and streaming continues from the transmitter computing device 102 to the receiver display device 104 via the wireless connection 108. In some embodiments, a user can toggle between setting up a backup wireless connection. In some embodiments, a user can input a preferred backup connection (for example, if an HDMI wired connection is being used as the wired connection, then a backup wireless Miracast connection is preferred by the user to be used upon disconnect of the HDMI wired connection, and/or if a DisplayPort wired connection is being used as the wired connection, then a backup wireless WiGig connection is preferred by the user to be used upon disconnect of the DisplayPort wired connection, etc.)

In some embodiments, device 102 is a transmitter device that can transmit content (for example, display content) and/or device 104 is a receiver device that can receive content (for example, display content). In some embodiments, device 102 can also be a receiver device (for example, device 102 can be a transceiver device that can transmit and receive content such as display content). In some embodiments, device 104 can also be a transmitter device (for example, device 104 can be a transceiver device that can transmit and receive content such as display content). FIG. 1 illustrates device 104 as a display device. However, in some embodiments, device 104 can be a device such as another electronic device and/or computing device that is not able to display content, and/or does not actually display the content transmitted from device 102 to device 104. In some embodiments, device 104 can be a receiver device with a display panel (for example, a monitor or an HDTV), while in some embodiments, device 104 can be a device without its own display panel (for example, a device such as a set top box, Apple TV, Roku, etc). For example, in addition to being a receiver device that can receive content, device 104 may be a device that can transmit content such as display content to another device for display on that device, for example. In some embodiments, device 104 can be, for example, a mobile phone, smart phone, mobile device, handset, laptop computer, desktop computer, tablet computer, cable box, high definition (HD) display device, computer monitor, television (TV), high definition television (HDTV), satellite box, set top box, video and/or image streaming device, video and/or image transmitting device, projector, repeater, re-transmitter, streaming device, display hub, Apple TV device, Chromecast device, and/or Roku device, among others.

FIG. 2 illustrates a display connection system 200. In some embodiments, display connection system 200 is a display connection switching system. Display connection system 200 includes a user input device 202, a discovery manager 204, a backup policy manager 206, and an evaluation manager 208. In some embodiments, discovery manager 204, backup policy manager 206, and evaluation manager 208 can be implemented in software. In some embodiments, discovery manager 204, backup policy manager 206, and evaluation manager 208 can be implemented in an Operating System (OS). In some embodiments, display connection system 200 is implemented in a transmitting device that can transmit content that can be displayed (for example, in some embodiments display connection system 200 is implemented in transmitting device 102).

Display connection system 200 can include a number of drivers for various connection protocols. In some embodiments, the various connection protocols can be wired connection protocols. In some embodiments, the various connection protocols can be wireless connection protocols. In some embodiments, the various connection protocols can include both wired connection protocols and wireless connection protocols. The various wired connection protocols can include, for example, a high-definition multimedia interface (HDMI) protocol, Thunderbolt protocol, DisplayPort protocol, DVI, VGA, Display over USB (USB Display), and/or some other wired protocol, communication link, and/or other wired communication methodology. The various wireless protocols can include, for example, Miracast, WiGig, WiDi, WiFi, WiFi-Direct, Apple Airplay, Google Chromecast, and/or some other wireless protocol, communication link, and/or other wireless communication methodology.

Display connection system 200 can include, for example, wired connection drivers including an HDMI driver 212 and a DisplayPort driver 214. Display connection system 200 can include, for example, wireless connection drivers including WiGig driver 216 and WiFi/WiFi-Direct driver 218. While FIG. 2 illustrates HDMI driver 212, DisplayPort driver 214, WiGig driver 216 and WiFi/WiFi-Direct driver 218, other drivers can be included in system 200 in place of one or more of drivers 212, 214, 216 and 218, and/or other drivers can be included in system 200 in addition to one or more of drivers 212, 214, 216 and 218.

User input device 202 represents any device and/or methodology of receiving user input. For example, user input device 202 can include any type of user interface (UI) and/or an application for user input. User input device 202 can include receiving user input via an input such as a touch screen or a keyboard. In some embodiments, user input device 202 includes a user level application with user interface (UI) through which a user of a device can configure a backup policy. For example, a user might configure a backup policy in which a Miracast wireless connection is identified as a backup connection protocol for an HDMI wired connection, and/or in which a WiGig wireless connection is identified as a backup connection protocol for a DisplayPort wired connection, etc. Backup policies input by the user via the user input device 202 are provided to backup policy manager 206.

Discovery manager 204 can discover backup interfaces available on a transmitting device and/or a receiving device (for example, on a peer device and/or on a display device). In some embodiments, discovery manager 204 can discover backup wireless interfaces available on a transmitting device and/or a receiving device. Discovery manager 204 can use a variety of different ways to determine a backup connection protocol, and can provide discovered backup interface protocols to backup policy manager 206.

Evaluation manager 208 can evaluate a current transport medium (for example, a current wired transport medium) in terms of stream types, codecs used, bandwidth required, frame-rate, etc. Evaluation manager 208 can provide the evaluated information to the backup policy manager 206, which can use that information to determine a best backup medium (for example, a best wireless backup medium) for the current transport medium (for example, a current wired transport medium).

Backup policy manager 206 can contain a policy to decide which interface (for example, which wireless interface) to use as a backup for a particular medium (for example, for a particular wired medium). Backup policy manager 206 can use inputs from the user via user input 202, from discovery manager 204, and/or from evaluation manager 208 to determine a best transport medium for another medium (for example, to determine a best wireless transport medium as backup for a particular wired medium). Backup policy manager 206 can also set a priority for backup mediums. For example, backup policy manager 206 can set a priority of WiGig over Miracast for 4k content in some embodiments. Backup policy manager 206 uses its settings, determinations, etc. to provide control to a variety of drivers for various protocols. For example, in some embodiments, backup manager controls HDMI driver 212, DisplayPort driver 214, WiGig driver 216 and WiFi/WiFi-Direct driver 218.

User input 202, discovery manager 204, backup policy manager 206 and evaluation manager 208 can be used in some embodiments to facilitate a seamless switching of display protocols (for example, in some embodiments to facilitate a seamless switching of a wired communication protocol interconnect to a wireless communication protocol interconnect).

In some embodiments, a user pairs in advance a transmitting device (for example, a computing device) with a receiving device (for example, a display device) using one or more communication protocols (for example, using one or more intended backup communication protocols). Since a first-time pairing can require some form of authentication, if a user pairs the transmitting device with the receiving device in advance using one or more intended backup communication protocols (and/or all intended backup communication protocols), an advance pairing by a user can ensure a more seamless transition to the backup communication protocol according to some embodiments. In some embodiments, a manufacturer such as, for example, an Original Equipment Manufacturer (OEM) might sell or bundle a transmitting device with a receiving device and pre-pair the devices using one or more backup communication protocols, which may avoid an advance pairing by the user.

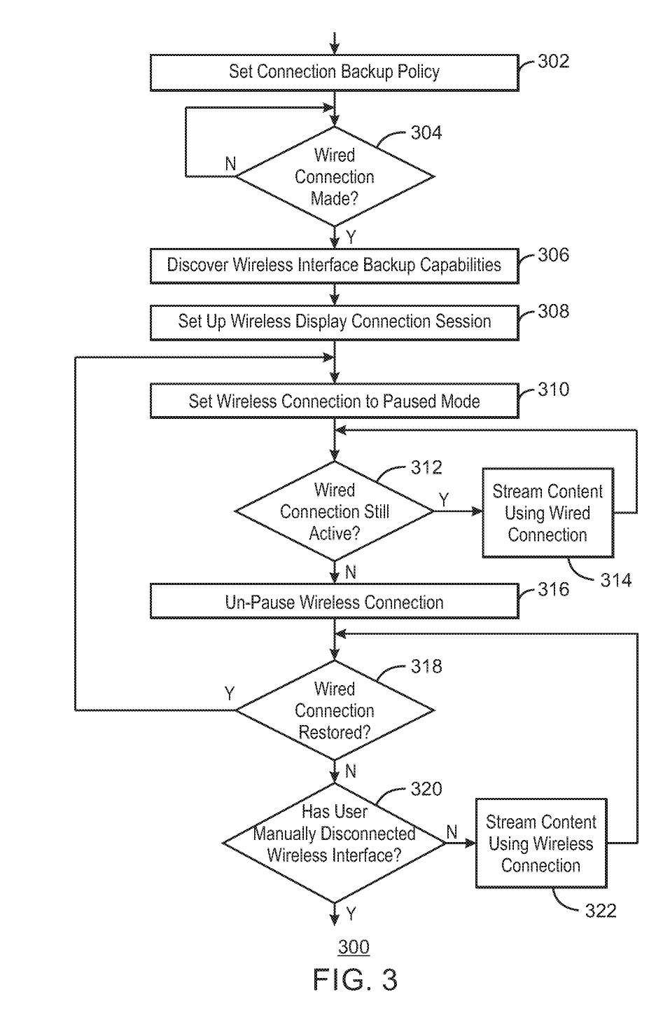

FIG. 3 illustrates display connection switching 300 according to some embodiments. In some embodiments, display connection switching 300 can be implemented in any of the systems described herein (for example, in system 100, system 200, and/or system 400). In some embodiments, display connection switching 300 is implemented in a transmitting device that can transmit content that can be displayed (for example, in some embodiments display connection switching 300 is implemented in transmitting device 102).

At box 302 display connection switching 300 sets a connection backup policy. Box 304 determines whether a primary wired connection has been made. Once a wired connection has been made at 304, box 306 discovers backup wireless backup connection capabilities. A backup wireless display connection session is then set up at 308. At 310, the backup wireless display connection session is set to a paused mode. If it is determined that the primary wired connection is still active at 312, content is streamed using the primary wired connection at 314 (for example, from a transmitting device to a receiving device). Content is continued to be streamed at 314 until it is determined at 312 the primary wired connection is no longer active (for example, in some embodiments in response to an unplugging of the primary wired connection between a transmitting device and a receiving device). Once it is determined at 314 that the primary wired connection is no longer active, the backup wireless connection is un-paused at 316. If it is then determined at 318 that the primary wired connection has been restored, the backup wireless connection is again paused at 308 and flow continues. However, if it is determined at 318 that the primary wired connection has not been restored, and it is determined at 320 that the user has not manually disconnected the backup wireless connection, then content is streamed using the backup wireless connection at 322 (for example, from the transmitting device to the receiving device). Content is continued to be streamed at 322 until it is determined at 318 that the primary wired connection has been restored or it is determined at 320 that the user has manually disconnected the backup wireless connection.

It is noted that FIG. 3 and other embodiments have been described herein as having a primary connection that is a wired connection and a backup connection that is a wireless connection. However, it is noted that other embodiments do not require that the primary connection be a wired connection and/or that the backup connection be a wireless connection. For example, in some embodiments, both the primary and backup connections can be wired connections, both the primary and backup can be wireless connections, etc.

In some embodiments of FIG. 3 and in some other embodiments, operational flow can include one or more of the following. Flow need not include all of the following, and/or can be different than the following. This operational flow is shown as an example of some embodiments. In some embodiments, the following operational flow is implemented in a transmitting device that can transmit content that can be displayed (for example, in some embodiments the following operational flow is implemented in transmitting device 102).

In some embodiments, a policy can be set in a transmitting device to choose a wireless display method, connection, and/or protocol as a backup upon an occurrence where a wired connection is later unplugged (for example, for a later occurrence of a connected wired video out port is unplugged). The set policy can be overridden manually in some embodiments by user input via a user input provided on the device or in some embodiments by manufacturer configuration such as a manufacturer provided configuration file (for example, a Miracast connection is set as a backup for an HDMI connection, and/or a WiGig connection is set up as a backup for a DVI connection).

In some embodiments, when the transmitting device is connected to the receiving device via a wired interface, the transmitting device and the receiving device can exchange information on available backup interfaces that are active. For example, they may use one of the wireless interfaces to discover each other's capabilities corresponding to supported interfaces. It is noted that this interface need not be the same one that is actually used for connection. For example, a Bluetooth connection such as a Bluetooth Low Energy (BLE) stack can be used to discover whether the other device supports Miracast, WiGig, etc., while the actual backup connection is made, for example, over Wi-Fi Direct, Miracast, etc. In order to discover active physical interfaces, Extended Display Identification Data (EDID) information can be obtained through a currently connected wired link, for example.

In some embodiments, based on the transmitters backup connection policy and availability of a required wireless display transmission connection protocol on the receiver, the transmitter and/or the receiver can set up a wireless display session soon after the wired connection is made. The set up can be initiated in some embodiments from the transmitter, and the set up can be initiated in some embodiments from the receiver. The wireless display session can exchange media capabilities and setup the pipeline, without streaming any content (for example, audio video content) over the wireless connection while maintaining the wireless connection in a paused state.

In some embodiments, media streaming of content occurs on the wired interface until the wire is unplugged (for example, at either the transmitter or the receiver). An unplug event at either the transmitter or the receiver can result in a trigger to the paused backup connection, which may create an un-pause event for the wireless connection session. Media content on the transmitter can now be redirected from the wired interface to the wireless interface and streamed to the receiver via the backup wireless display interface. Since the backup wireless session can be pre-established, the transition can be quick and without any user visible glitch (and/or with a minimal user visible glitch).

The unplug event can be detected at the receiver end as well as the transmitter end. In this manner, both transmitter and receiver can detect the unplug event and switch to the earlier established backup connection.

Upon later restoration of the wired connection, the hot-plug event associated with the restoration can trigger a pause of the backup wireless display session, and media can be redirected to the wired interface. In this manner, streaming of media content can continue again from the transmitter to the receiver on the primary wired connection in a seamless manner. The backup wireless display session is then again set to a paused state so that it can again remain in the background and wait for another unplug event of the primary wired connection.

When the user is done using the primary wired interface and does not want the backup wireless interface to remain active in the background, the user can disconnect the backup wireless interface manually through a user interface provided for the backup wireless display (for example, in some embodiments, using user input device 202). The user can disconnect the backup wireless interface at any time—that is, the user can disconnect the backup wireless interface while the primary wired interface is in a connected or a disconnected state.

In some embodiments, display connection switching can be implemented in any device by an OEM for a better user experience. For example, in some embodiments, display connection switching can be implemented by an OEM in one or more of a computing device, mobile phone, smart phone, mobile device, handset, laptop computer, desktop computer, tablet computer, cable box, satellite box, set top box, television (TV), high definition television (HDTV), video and/or image streaming device, video and/or image transmitting device, Apple TV device, Chromecast device, Roku device, repeater, re-transmitter, streaming device, display hub, high definition (HD) display device, computer monitor, television (TV), high definition television (HDTV), and/or projector, among others. In some embodiments, display connection switching may be implemented in a processor and/or in a System on Chip (SoC) package (for example, with supporting software and/or to allow seamless switching between display connections such as wired and wireless connections).

In some embodiments, a user connects a smart phone via a wired USB Display connection protocol to an HDTV, and starts and app on the smart phone that can play movies on a second display screen (that is, on a screen that is not the display screen that is part of the smart phone). The movie starts on the display screen of the HDTV that is coupled to the smart phone via the wired USB Display connection protocol. While the movie is being transmitted from the smart phone and played on the HDTV, the user gets a phone call on the smart phone. The user decides to let others continue to watch the movie on the HDTV while the user takes the call on the smart phone in another room from where the HDTV is displaying the movie. The user disconnects the wired USB Display connection between the smart phone and the HDTV and moves to the other room to talk on the smart phone. After disconnection of the wired USB Display interface, the movie continues to be transmitted from the smart phone to the HDTV via a backup wireless connection according to some embodiments described herein. After the user is done with the call, the user plugs the smart phone back into the USB Display connection so that it can continue to charge via the USB Display connection with the HDTV. The other viewers of the movie on the HDTV continue to watch the movie the entire time with no (or little) perceived interruption during the unplugging, the phone call, and/or the re-plugging event.

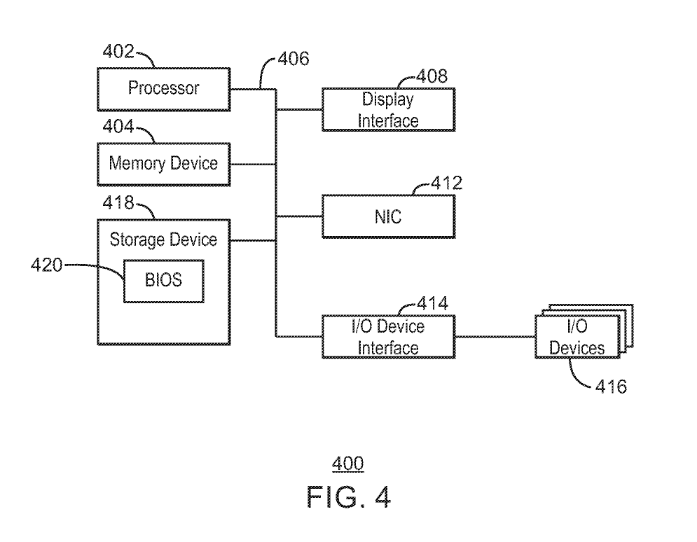

FIG. 4 is a block diagram of an example of a computing device 400 that can implement display connection switching (for example, wired to wireless display connection switching). In some embodiments, computing device 400 can be similar to and/or the same as computing device 102. In some embodiments, computing device 400 can be any electronic device. In some embodiments, computing device 400 can be any computing device that can output data that could be displayed on a display device. In some embodiments, any portion of any of the features, operations and/or systems illustrated in any one or more of the figures and/or described herein can be included in and/or be implemented by computing device 400. For example, computing device 400 can include a display connection switching system as illustrated in FIG. 2 and/or display connection switching as illustrated in FIG. 3. The computing device 400 may be, for example, a mobile phone, smart phone, mobile device, handset, laptop computer, desktop computer, tablet computer, cable box, satellite box, set top box, television (TV), high definition television (HDTV), video and/or image streaming device, video and/or image transmitting device, repeater, re-transmitter, streaming device, display hub, Apple TV device, Chromecast device, and/or Roku device, among others. In some embodiments, computing device 400 can be a device with its own built in display. In some embodiments, computing device 400 can be a device that does not have its own built in display. The computing device 400 may include a processor 402 that is adapted to execute stored instructions, as well as a memory device 404 (and/or storage device 404) that stores instructions that are executable by the processor 402. The processor 402 can be a single core processor, a multi-core processor, a computing cluster, or any number of other configurations. For example, processor 402 can be an Intel® processor such as an Intel® Celeron, Pentium, Core, Core i3, Core i5, or Core i7 processor. In some embodiments, processor 402 can be an Intel® x86 based processor. In some embodiments, processor 402 can be an ARM based processor. The memory device 404 can be a memory device and/or a storage device, and can include volatile storage, non-volatile storage, random access memory, read only memory, flash memory, or any other suitable memory or storage systems. The instructions that are executed by the processor 402 may also be used to implement display connection, display connection switching, etc. as described in this specification and/or illustrated in FIGS. 1-3.

The processor 402 may also be linked through the system interconnect 406 (e.g., PCI®, PCI-Express®, NuBus, etc.) to a display interface 408 adapted to connect the computing device 400 to one or more display devices. The display device may include a display screen that is a built-in component of the computing device 400. The display device may also include a high definition display device, computer monitor, television (TV), high definition television (HDTV), projector, repeater, re-transmitter, streaming device, and/or a display hub, among others, that is externally connected to the computing device 400.

In some embodiments, the display interface 408 can include any suitable graphics processing unit, transmitter, port, physical interconnect, and the like. In some examples, the display interface 408 can implement any suitable protocol for transmitting data to the display device. For example, the display interface 408 can transmit data using a high-definition multimedia interface (HDMI) protocol, a Thunderbolt protocol, a DisplayPort protocol, DVI, VGA, Display over USB (USB Display), Miracast, WiGig, WiDi, WiFi, WiFi-Direct, Apple Airplay, Google Chromecast, or some other wired or wireless protocol or communication link, and the like. In some embodiments, instructions may be stored in memory device 404 and/or in storage device 420 that may be adapted to direct the processor 402 to perform one or more of any of the operations described in this specification and/or illustrated in any of the figures. In some embodiments, the display interface 408 can perform one or more of any of the operations described in this specification and/or illustrated in any of the figures. In some embodiments, instructions may be stored in memory device 404 and/or in storage device 420 that may be adapted to direct the display interface 408 to perform one or more of any of the operations described in this specification and/or illustrated in any of the figures.

In addition, one or more network interface controllers (also referred to herein as a NIC) 412 may be adapted to connect the computing device 400 through the system interconnect 406 to one or more networks or devices (not depicted). The network (not depicted) may be a cellular network, a radio network, a wide area network (WAN), a local area network (LAN), or the Internet, among others. In some embodiments, one or more NIC 412 can include a wireless device to connect to a GPS network, and/or to one or more satellites (for example, one or more GPS satellites).

The processor 402 may be connected through system interconnect 406 to an input/output (I/O) device interface 414 adapted to connect the computing host device 400 to one or more I/O devices 416. The I/O devices 416 may include, for example, a keyboard and/or a pointing device, where the pointing device may include a touchpad or a touchscreen, among others. The I/O devices 416 may be built-in components of the computing device 400, or may be devices that are externally connected to the computing device 400.

In some embodiments, the processor 402 may also be linked through the system interconnect 406 to a storage device 418 that can include a hard drive, a solid state drive (SSD), a magnetic drive, an optical drive, a USB flash drive, an array of drives, or any other type of storage, including combinations thereof. In some embodiments, the storage device 418 can include any suitable applications. In some embodiments, the storage device 418 can include a basic input/output system (BIOS).

In some embodiments, one or more transmitters, one or more receivers, and/or one or more transceivers may be included in device 400. For example, in some embodiments, the one or more transmitters, one or more receivers, and/or one or more transceivers can be coupled to system interconnect 406. In some embodiments, the one or more transmitters, one or more receivers, and/or one or more transceivers can be included in display interface 408. In some embodiments, the one or more transmitters, one or more receivers, and/or one or more transceivers can be used to transmit and/or receive content that can be viewed on a display device according to any of the embodiments described herein and/or illustrated in the drawings.

It is to be understood that the block diagram of FIG. 4 is not intended to indicate that the computing device 400 is to include all of the components shown in FIG. 4. Rather, the computing device 400 can include fewer or additional components not illustrated in FIG. 4 (e.g., additional memory components, embedded controllers, additional modules, additional network interfaces, etc.) In some embodiments, instructions may be stored in memory device 404 and/or in storage device 420 that may be adapted to direct the processor 402 to perform one or more of any of the operations described in this specification and/or illustrated in any of the figures.

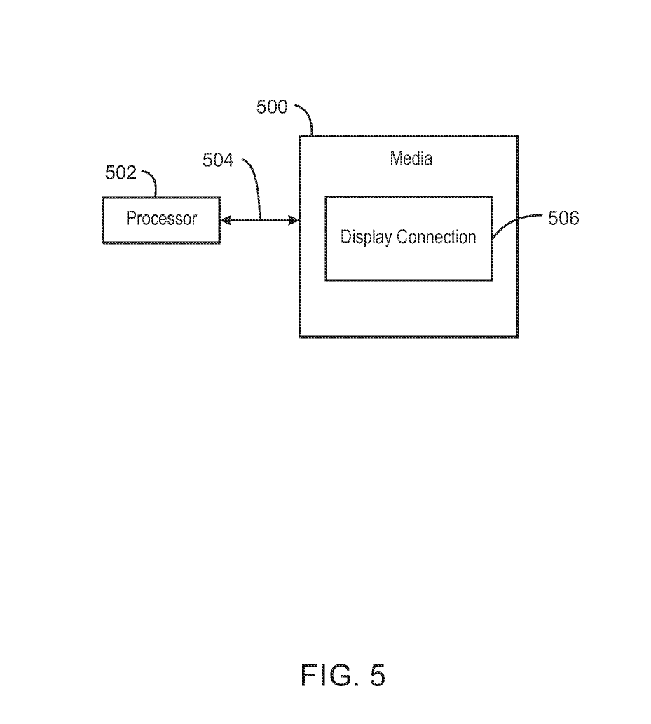

FIG. 5 is a block diagram of an example of a processor and one or more tangible, non-transitory computer readable media for display switching (for example, for wired to wireless display switching). The one or more tangible, non-transitory, computer-readable media 500 may be accessed by the processor 502 over a computer interconnect 504. Furthermore, the one or more tangible, non-transitory, computer-readable media 500 may include code to direct the processor 502 to perform operations as described herein. In some embodiments, processor 502 is one or more processors. In some embodiments, processor 502 can perform similarly to (and/or the same as) processor 402 of FIG. 4, and can perform some or all of the same functions as can be performed by processor 402.

Various components discussed in this specification may be implemented using software components. These software components may be stored on the one or more tangible, non-transitory, computer-readable media 500, as indicated in FIG. 5. For example, display connection instructions 506 (for example, display connection switching instructions) may be adapted to direct the processor 502 to perform one or more of any of the operations described in this specification and/or illustrated in any of the figures. For example, in some embodiments, display connection instructions 506 can be adapted to direct processor 502 to perform display connection, display connection switching, and/or wireless connection backup as described herein.

It is to be understood that any suitable number of the software components shown in FIG. 5 may be included within the one or more tangible, non-transitory computer-readable media 500. Furthermore, any number of additional software components not shown in FIG. 5 may be included within the one or more tangible, non-transitory, computer-readable media 500, depending on the specific application.

Reference in the specification to “one embodiment” or “an embodiment” or “some embodiments” of the disclosed subject matter means that a particular feature, structure, or characteristic described in connection with the embodiment is included in at least one embodiment of the disclosed subject matter. Thus, the phrase “in one embodiment” or “in some embodiments” may appear in various places throughout the specification, but the phrase may not necessarily refer to the same embodiment or embodiments.

### Example 1

In some examples, an apparatus includes storage to store instructions executable by at least one processor, and at least one processor to execute the instructions. When executed, the instructions cause the at least one processor to determine a first connection made between a display content transmitting device and a display content receiving device. In response to the determined first connection, the instructions also cause the at least one processor to activate a second connection between the display content transmitting device and the display content receiving device, to pause the second connection, to determine a deactivation of the first connection, to un-pause the second connection in response to the deactivation of the first connection, and to stream display content from the transmitting device to the receiving device via the second connection.

### Example 2

In some examples, the apparatus of Example 1, where the first connection is a wired connection and the second connection is a wireless connection.

### Example 3

In some examples, the apparatus of Example 2, where the wired connection is a high-definition multimedia interface (HDMI) connector, a Thunderbolt connector, a DisplayPort connector, a Digital Visual Interface (DVI) connector, a Video Graphics Array (VGA) connector, and/or a Display over USB (USB Display) connector. The wireless connection transmits data using Miracast, Wireless Gigabit Alliance (WiGig), Wireless Display (WiDi), WiFi, WiFi-Direct, Apple Airplay, and/or Google Chromecast.

### Example 4

In some examples, the apparatus of Example 1, where the processor is included in the display content transmitting device.

### Example 5

In some examples, the apparatus of Example 1 where the display content transmitting device is one or more of an electronic device, a computing device, a mobile phone, a smart phone, a mobile device, a handset, a laptop computer, a desktop computer, a tablet computer, a cable box, a television (TV), a high definition television (HDTV), a satellite box, a set top box, a video and/or image streaming device, a video and/or image transmitting device, a repeater, a re-transmitter, a streaming device, a display hub, an Apple TV device, a Chromecast device, and/or a Roku device.

### Example 6

In some examples, the apparatus of Example 1, where the display content receiving device is a display device.

### Example 7

In some examples, the apparatus of Example 6, where the display device is one or more of a high definition (HD) display device, a computer monitor, a television (TV), a high definition television (HDTV), a projector, a repeater, a re-transmitter, a streaming device, and/or a display hub.

### Example 8

In some examples, the apparatus of Example 1, where the display content receiving device is a device without a display panel, and wherein the display content receiving device is also a display content transmitting device to transmit display content.

### Example 9

In some examples, the apparatus of Example 1, where the processor is to determine that the first connection has been reactivated and pause the second connection in response to the reactivation of the first connection. The processor is also to stream display content from the display content transmitting device to the display content receiving device via the first connection in response to the reactivation of the first connection.

### Example 10

In some examples, the apparatus of Example 1, where the deactivation of the first connection is an unplug event of the first connection.

### Example 11

In some examples, the apparatus of Example 1, where the first connection is a primary connection and the second connection is a backup connection.

### Example 12

In some examples, the apparatus of Example 1, where the processor is to stream display content from the display content transmitting device to the display content receiving device via the first connection when the first connection is activated.

### Example 13

In some examples, a method includes determining a first connection made between a display content transmitting device and a display content receiving device. In response to the determining of the first connection, the method includes activating a second connection between the display content transmitting device and the display content receiving device. The method also includes pausing the second connection, determining a deactivation of the first connection, un-pausing the second connection in response to the deactivation of the first connection, and streaming display content from the transmitting device to the receiving device via the second connection.

### Example 14

In some examples, the method of Example 13, where the first connection is a wired connection and the second connection is a wireless connection.

### Example 15

In some examples, the method of Example 13, where the display content receiving device is a display device.

### Example 16

In some examples, the method of Example 13, where the display content receiving device is a device without a display panel. The display content receiving device is also a display content transmitting device to transmit display content.

### Example 17

In some examples, the method of Example 13, including determining that the first connection has been reactivated, pausing the second connection in response to the reactivation of the first connection, and streaming display content from the display content transmitting device to the display content receiving device via the first connection in response to the reactivation of the first connection.

### Example 18

In some examples, the method of Example 13, where the first connection is a primary connection and the second connection is a backup connection.

### Example 19

In some examples, the method of Example 13, including streaming display content from the display content transmitting device to the display content receiving device via the first connection when the first connection is activated.

### Example 20

In some examples, one or more tangible, non-transitory machine readable media including a plurality of instructions. In response to being executed on at least one processor, the instructions cause the at least one processor to determine a first connection made between a display content transmitting device and a display content receiving device. In response to the determining of the first connection, the instructions cause the at least one processor to activate a second connection between the display content transmitting device and the display content receiving device. The instructions also cause the at least one processor to pause the second connection, determine a deactivation of the first connection, un-pause the second connection in response to the deactivation of the first connection, and stream display content from the transmitting device to the receiving device via the second connection.

### Example 21

In some examples, the one or more machine readable media of Example 20, where the first connection is a wired connection and the second connection is a wireless connection.

### Example 22

In some examples, the one or more machine readable media of Example 20, where the display content receiving device is a display device.

### Example 23

In some examples, the one or more machine readable media of Example 20, where the display content receiving device is a device without a display panel. The display content receiving device is also a display content transmitting device to transmit display content.

### Example 24

In some examples, the one or more machine readable media of Example 20, the plurality of instructions, in response to being executed on the at least one processor, cause the at least one processor to determine that the first connection has been reactivated, pause the second connection in response to the reactivation of the first connection, and stream display content from the display content transmitting device to the display content receiving device via the first connection in response to the reactivation of the first connection.

### Example 25

In some examples, the one or more machine readable media of Example 20, where the first connection is a primary connection and the second connection is a backup connection.

### Example 26

In some examples, the one or more machine readable media of Example 20, the plurality of instructions, in response to being executed on the at least one processor, cause the at least one processor to stream display content from the display content transmitting device to the display content receiving device via the first connection when the first connection is activated.

### Example 27

In some examples, an apparatus includes storage to store instructions executable by at least one processor. The apparatus also includes at least one processor to execute the instructions to determine a first connection made between a display content transmitting device and a display content receiving device. In response to the determined first connection, the at least one processor is to execute the instructions to activate a second connection between the display content transmitting device and the display content receiving device. The at least one processor is also to execute the instructions to pause the second connection, determine a deactivation of the first connection, un-pause the second connection in response to the deactivation of the first connection, and stream display content from the transmitting device to the receiving device via the second connection.

### Example 28

In some examples, the apparatus of Example 27, where the first connection is a wired connection and the second connection is a wireless connection.

### Example 29

In some examples, the apparatus of Example 28, where the wired connection is a high-definition multimedia interface (HDMI) connector, a Thunderbolt connector, a DisplayPort connector, a Digital Visual Interface (DVI) connector, a Video Graphics Array (VGA) connector, or a Display over USB (USB Display) connector. The wireless connection transmits data using Miracast, Wireless Gigabit Alliance (WiGig), Wireless Display (WiDi), WiFi, WiFi-Direct, Apple Airplay, or Google Chromecast.

### Example 30

In some examples, the apparatus of any of Examples 27-29, where the processor is included in the display content transmitting device.

### Example 31

In some examples, the apparatus of any of Examples 27-29, where the display content transmitting device is one or more of an electronic device, a computing device, a mobile phone, a smart phone, a mobile device, a handset, a laptop computer, a desktop computer, a tablet computer, a cable box, a television (TV), a high definition television (HDTV), a satellite box, a set top box, a video and/or image streaming device, a video and/or image transmitting device, a repeater, a re-transmitter, a streaming device, a display hub, an Apple TV device, a Chromecast device, and/or a Roku device.

### Example 32

In some examples, the apparatus of any of Examples 27-29, where the display content receiving device is a display device.

### Example 33

In some examples, the apparatus of Example 32, where the display device is one or more of a high definition (HD) display device, a computer monitor, a television (TV), a high definition television (HDTV), a projector, a repeater, a re-transmitter, a streaming device, and/or a display hub.

### Example 34

In some examples, the apparatus of any of Examples 27-29, where the display content receiving device is a device without a display panel. The display content receiving device is also a display content transmitting device to transmit display content.

### Example 35

In some examples, the apparatus of any of Examples 27-29, where the processor is to determine that the first connection has been reactivated, pause the second connection in response to the reactivation of the first connection, and stream display content from the display content transmitting device to the display content receiving device via the first connection in response to the reactivation of the first connection.

### Example 36

In some examples, the apparatus of any of Examples 27-29, where the deactivation of the first connection comprises an unplug event of the first connection.

### Example 37

In some examples, the apparatus of any of Examples 27-29, where the first connection is a primary connection and the second connection is a backup connection.

### Example 38

In some examples, the apparatus of any of Examples 27-29, the processor to stream display content from the display content transmitting device to the display content receiving device via the first connection when the first connection is activated.

### Example 39

In some examples, a method includes determining a first connection made between a display content transmitting device and a display content receiving device. In response to the determining of the first connection, the method includes activating a second connection between the display content transmitting device and the display content receiving device. The method also includes pausing the second connection, determining a deactivation of the first connection, un-pausing the second connection in response to the deactivation of the first connection, and streaming display content from the transmitting device to the receiving device via the second connection.

### Example 40

In some examples, the method of Example 39, where the first connection is a wired connection and the second connection is a wireless connection.

### Example 41

In some examples, the method of Example 39, wherein the display content receiving device is a display device.

### Example 42

In some examples, the method of Example 39, where the display content receiving device is a device without a display panel. The display content receiving device is also a display content transmitting device to transmit display content.

### Example 43

In some examples, the method of any of Examples 39-42, including determining that the first connection has been reactivated, pausing the second connection in response to the reactivation of the first connection, and streaming display content from the display content transmitting device to the display content receiving device via the first connection in response to the reactivation of the first connection.

### Example 44

In some examples, the method of any of Examples 39-42, including streaming display content from the display content transmitting device to the display content receiving device via the first connection when the first connection is activated.

### Example 45

In some examples, a machine readable medium including code, when executed, to cause a machine to perform the method of any of Examples 39-44.

### Example 46

In some examples, one or more tangible, non-transitory machine readable media comprising a plurality of instructions. In response to being executed on at least one processor, the instructions cause the at least one processor to determine a first connection made between a display content transmitting device and a display content receiving device. The instructions also cause the at least one processor, in response to the determining of the first connection, to activate a second connection between the display content transmitting device and the display content receiving device. The instructions also cause the at least one processor to pause the second connection, determine a deactivation of the first connection, un-pause the second connection in response to the deactivation of the first connection, and stream display content from the transmitting device to the receiving device via the second connection.

### Example 47

In some examples, the one or more machine readable media of Example 46, the plurality of instructions, in response to being executed on the at least one processor, cause the at least one processor to determine that the first connection has been reactivated, pause the second connection in response to the reactivation of the first connection, and stream display content from the display content transmitting device to the display content receiving device via the first connection in response to the reactivation of the first connection.

### Example 48

In some examples, the one or more machine readable media of any of Examples 46-47, the plurality of instructions, in response to being executed on the at least one processor, cause the at least one processor to stream display content from the display content transmitting device to the display content receiving device via the first connection when the first connection is activated.

### Example 49

In some examples, an apparatus, includes means to determine a first connection made between a display content transmitting device and a display content receiving device, means to activate a second connection between the display content transmitting device and the display content receiving device in response to the determined first connection, means to pause the second connection, means to determine a deactivation of the first connection, means to un-pause the second connection in response to the deactivation of the first connection, and means to stream display content from the transmitting device to the receiving device via the second connection.

### Example 50

In some examples, the apparatus of Example 49, including means to determine that the first connection has been reactivated, means to pause the second connection in response to the reactivation of the first connection, and means to stream display content from the display content transmitting device to the display content receiving device via the first connection in response to the reactivation of the first connection.

### Example 51

In some examples, the apparatus of Example 49, where the means to determine a deactivation of the first connection comprises means to detect an unplug event of the first connection.

### Example 52

In some examples, the apparatus of any of Examples 49-51, including means to stream display content from the display content transmitting device to the display content receiving device via the first connection when the first connection is activated.

### Example 53

In some examples, a method including determining a first connection made between a display content transmitting device and a display content receiving device. In response to the determined first connection, the method includes activating a second connection between the display content transmitting device and the display content receiving device. The method also includes pausing the second connection, determining a deactivation of the first connection, un-pausing the second connection in response to the deactivation of the first connection, and streaming display content from the transmitting device to the receiving device via the second connection.

### Example 54

In some examples, the method of Example 53, where the first connection is a wired connection and the second connection is a wireless connection.

### Example 55

In some examples, the method of Example 54, where the wired connection is a high-definition multimedia interface (HDMI) connector, a Thunderbolt connector, a DisplayPort connector, a Digital Visual Interface (DVI) connector, a Video Graphics Array (VGA) connector, or a Display over USB (USB Display) connector. The wireless connection transmits data using Miracast, Wireless Gigabit Alliance (WiGig), Wireless Display (WiDi), WiFi, WiFi-Direct, Apple Airplay, or Google Chromecast.

### Example 56

In some examples, the method of any of the preceding Examples, where the method is implemented in the display content transmitting device.

### Example 57

In some examples, the method of any of the preceding Examples, where the display content transmitting device is one or more of an electronic device, a computing device, a mobile phone, a smart phone, a mobile device, a handset, a laptop computer, a desktop computer, a tablet computer, a cable box, a television (TV), a high definition television (HDTV), a satellite box, a set top box, a video and/or image streaming device, a video and/or image transmitting device, a repeater, a re-transmitter, a streaming device, a display hub, an Apple TV device, a Chromecast device, and/or a Roku device.

### Example 58

In some examples, the method of any of the preceding Examples, where the display content receiving device is a display device.

### Example 59

In some examples, the method of any of the preceding Examples, where the display device is one or more of a high definition (HD) display device, a computer monitor, a television (TV), a high definition television (HDTV), a projector, a repeater, a re-transmitter, a streaming device, and/or a display hub.

### Example 60

In some examples, the method of any of the preceding Examples, where the display content receiving device is a device without a display panel. The display content receiving device is also a display content transmitting device to transmit display content.

### Example 61

In some examples, the method of any of the preceding Examples, including determining that the first connection has been reactivated, pausing the second connection in response to the reactivation of the first connection, and streaming display content from the display content transmitting device to the display content receiving device via the first connection in response to the reactivation of the first connection.

### Example 62

In some examples, the method of any of the preceding Examples, where the deactivation of the first connection includes an unplug event of the first connection.

### Example 63

In some examples, the method of any of the preceding Examples, where the first connection is a primary connection and the second connection is a backup connection.

### Example 64

In some examples, the method of any of the preceding Examples, including streaming display content from the display content transmitting device to the display content receiving device via the first connection when the first connection is activated.

### Example 65

In some examples, an apparatus including means to perform a method as in any preceding Example.

### Example 66

In some examples, machine-readable storage including machine-readable instructions, when executed, to implement a method or realize an apparatus as in any preceding Example.

Although example embodiments of the disclosed subject matter are described with reference to the drawings, persons of ordinary skill in the art will readily appreciate that many other ways of implementing the disclosed subject matter may alternatively be used. For example, the order of execution of the blocks in flow diagrams may be changed, and/or some of the blocks in block/flow diagrams described may be changed, eliminated, or combined. Additionally, some of the circuit and/or block elements may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter. For example, in each illustrated embodiment and each described embodiment, it is to be understood that the diagrams of the figures and the description herein is not intended to indicate that the illustrated or described devices include all of the components shown in a particular figure or described in reference to a particular figure. In addition, each element may be implemented with logic, wherein the logic, as referred to herein, can include any suitable hardware (e.g., a processor, among others), software (e.g., an application, among others), firmware, or any suitable combination of hardware, software, and firmware, for example.

1. An apparatus, comprising:
storage to store instructions executable by at least one processor; and
at least one processor to execute the instructions to:
determine a first connection made between a display content transmitting device and a display content receiving device;
in response to the determined first connection, activate a second connection between the display content transmitting device and the display content receiving device;
pause the second connection;
determine a deactivation of the first connection;
un-pause the second connection in response to the deactivation of the first connection; and
stream display content from the transmitting device to the receiving device via the second connection.

2. The apparatus of claim 1, wherein the first connection is a wired connection and the second connection is a wireless connection.

3. The apparatus of claim 2, wherein the wired connection is a high-definition multimedia interface (HDMI) connector, a Thunderbolt connector, a DisplayPort connector, a Digital Visual Interface (DVI) connector, a Video Graphics Array (VGA) connector, or a Display over USB (USB Display) connector, and wherein the wireless connection transmits data using Miracast, Wireless Gigabit Alliance (WiGig), Wireless Display (WiDi), WiFi, WiFi-Direct, Apple Airplay, or Google Chromecast.

4. The apparatus of claim 1, wherein the processor is included in the display content transmitting device.

5. The apparatus of claim 1, wherein the display content transmitting device is one or more of an electronic device, a computing device, a mobile phone, a smart phone, a mobile device, a handset, a laptop computer, a desktop computer, a tablet computer, a cable box, a television (TV), a high definition television (HDTV), a satellite box, a set top box, a video and/or image streaming device, a video and/or image transmitting device, a repeater, a re-transmitter, a streaming device, a display hub, an Apple TV device, a Chromecast device, or a Roku device.

6. The apparatus of claim 1, wherein the display content receiving device is a display device.

7. The apparatus of claim 6, wherein the display device is one or more of a high definition (HD) display device, a computer monitor, a television (TV), a high definition television (HDTV), a projector, a repeater, a re-transmitter, a streaming device, or a display hub.

8. The apparatus of claim 1, wherein the display content receiving device is a device without a display panel, and wherein the display content receiving device is also a display content transmitting device to transmit display content.

9. The apparatus of claim 1, the processor to:
determine that the first connection has been reactivated;
pause the second connection in response to the reactivation of the first connection; and
stream display content from the display content transmitting device to the display content receiving device via the first connection in response to the reactivation of the first connection.

10. The apparatus of claim 1, wherein the first connection comprises a primary connection and the second connection comprises a backup connection.

11. The apparatus of claim 1, the processor to stream display content from the display content transmitting device to the display content receiving device via the first connection when the first connection is activated.

12. A method comprising:
determining a first connection made between a display content transmitting device and a display content receiving device;
in response to the determining of the first connection, activating a second connection between the display content transmitting device and the display content receiving device;
pausing the second connection;
determining a deactivation of the first connection;
un-pausing the second connection in response to the deactivation of the first connection; and
streaming display content from the transmitting device to the receiving device via the second connection.

13. The method of claim 12, wherein the first connection is a wired connection and the second connection is a wireless connection.

14. The method of claim 12, wherein the display content receiving device is a display device.

15. The method of claim 12, wherein the display content receiving device is a device without a display panel, and wherein the display content receiving device is also a display content transmitting device to transmit display content.

16. The method of claim 12, comprising:
determining that the first connection has been reactivated;
pausing the second connection in response to the reactivation of the first connection; and
streaming display content from the display content transmitting device to the display content receiving device via the first connection in response to the reactivation of the first connection.

17. The method of claim 12, wherein the first connection comprises a primary connection and the second connection comprises a backup connection.

18. The method of claim 12, comprising streaming display content from the display content transmitting device to the display content receiving device via the first connection when the first connection is activated.

19. One or more tangible, non-transitory machine readable media comprising a plurality of instructions that, in response to being executed on at least one processor, cause the at least one processor to:
determine a first connection made between a display content transmitting device and a display content receiving device;
in response to the determining of the first connection, activate a second connection between the display content transmitting device and the display content receiving device;
pause the second connection;
determine a deactivation of the first connection;
un-pause the second connection in response to the deactivation of the first connection; and
stream display content from the transmitting device to the receiving device via the second connection.

20. The one or more machine readable media of claim 19, wherein the first connection is a wired connection and the second connection is a wireless connection.

21. The one or more machine readable media of claim 19, wherein the display content receiving device is a display device.

22. The one or more machine readable media of claim 19, wherein the display content receiving device is a device without a display panel, and wherein the display content receiving device is also a display content transmitting device to transmit display content.

23. The one or more machine readable media of claim 19, the plurality of instructions, in response to being executed on the at least one processor, cause the at least one processor to:
determine that the first connection has been reactivated;
pause the second connection in response to the reactivation of the first connection; and
stream display content from the display content transmitting device to the display content receiving device via the first connection in response to the reactivation of the first connection.

24. The one or more machine readable media of claim 19, wherein the first connection comprises a primary connection and the second connection comprises a backup connection.

25. The one or more machine readable media of claim 19, the plurality of instructions, in response to being executed on the at least one processor, cause the at least one processor to stream display content from the display content transmitting device to the display content receiving device via the first connection when the first connection is activated.
